(19) United States
(12) Patent Application Publication
(10) Pub. No.: US 2006/0141283 A1
(43) Pub. Date: Jun. 29, 2006

(54) Low cost inovative diffused MCrAIY coatings

(75) Inventor: Murali N. Madhava, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/027,152

(22) Filed: Dec. 29, 2004

(51) Int. Cl. C23C 2/12; B32B 15/00; C25D 5/10

(52) U.S. Cl. 428/651; 428/653; 428/655; 428/666; 428/667; 148/527

(57) ABSTRACT

The present invention provides a low cost diffused MCrAlYX type coating that may be used on a surface of gas turbine engine component such as a turbine blade. The coating may be used as a protective coating that impedes the progress of corrosion, oxidation, and sulfidation in superalloy materials that comprise the substrate of the turbine blade. The method of depositing the coating includes steps such as: (1) forming an active elements modified chromium diffusion coating; (2) depositing noble metals such as platinum to a thickness in the range of 3 to 6 microns through known procedures such as electroplating or PVD techniques; (3) performing a diffusion cycle in the temperature range of approximately 1800° F. to 2000° F.; (4) performing an aluminizing step to generate coating microstructures; and (5) optionally performing a post coat diffusion treatment in the 1900° F. to 2025° F. temperature range.

### FIELD OF THE INVENTION

The present invention relates to methods and materials for forming a protective coating on metallic industrial items. More particularly the invention relates to a method for applying an MCrAlY type coating through diffusion processes, unlike the conventional overlay coating method.

### BACKGROUND OF THE INVENTION

In an attempt to increase the efficiencies and performance of contemporary jet engines, and gas turbine engines generally, engineers have progressively pushed the engine environment to more extreme operating conditions. The harsh operating conditions of high temperature and pressure that are now frequently specified place increased demands on engine components and materials. Indeed the gradual change in engine design has come about in part due to the increased strength and durability of new materials that can withstand the operating conditions present in the modern gas turbine engine.

The high pressure turbine (HPT) components such as blades, vanes, and shrouds of modern gas turbine engines experience arduous operating conditions. The turbine blade, for example, is thus designed and manufactured to perform under repeated cycles of high stress and high temperature. An economic consequence of such a design criteria is that currently used turbine blades can be quite expensive. It is thus highly desirable to maintain turbine blades in service for as long as possible. It is correspondingly desirable to manufacture and finish turbine blades so as to withstand the corrosive and erosive forces that will attack turbine blade materials.

Turbine blades, like other HPT components, used in modern gas turbine engines are frequently castings made from a class of materials known as superalloys. The superalloys include alloys with high levels of cobalt and/or nickel. Therefore, nickel and cobalt based superalloys are thus preferred materials for the construction of turbine components, including blades and vanes. The high strength nickel-based superalloys are noted as precipitation hardening alloys. Nickel, alloyed with elements such as aluminum and titanium, develops high strength characteristics that are sustainable at high temperatures. The strength arises predominantly through the presence of a gamma prime (γ′) phase which is an intermetallic compound formed between Ni and Al or Ti or both in the material. One characteristic of the advanced nickel-based superalloys is the high degree of gamma prime (60% or more volume fraction) in cast materials.

In the cast form, turbine blades made from superalloys display many desirable physical properties and mechanical properties including high strength at elevated temperatures. Advantageously, the strength displayed by this class of materials remains present even under arduous conditions, such as high temperature and high pressure. Disadvantageously, the superalloys generally can be subject to corrosion and oxidation at the high temperature operating regime. Sulfidation can also occur in those turbine blades subject to hot exhaust gases.

Thus, it has become known to provide coatings or protective layers on engine components, such as turbine blades, that are subject to corrosion, erosion or sulfidation. Many components in the advanced turbine engine hot section, in addition to turbine blades, also require protective coatings for resistance to oxidation, sulfidation, and corrosion. Chromium, aluminum, and other metallic coatings can be used to provide protective layers that are more resistant to corrosion and/or oxidation than is the underlying substrate material. In the case of superalloys, materials such as platinum, aluminum, and chromium can be used to provide protective coatings.

Various coating types and various coating deposition systems have been developed. In extremely high temperature applications, a Thermal Barrier Coating (TBC) may be needed to provide the required heat resistance. A TBC typically is composed of ceramic materials such as zirconia, (ZrO₂), yttria (Y₂O₃), magnesia (MgO), or other oxides. Yttria Stabilized Zirconia (YSZ) is a widely used TBC. A TBC is often used in conjunction with an underlying metallic bond coat.

Metallic coating systems include diffusion-based coatings and overlay coatings. Commonly used diffusion coatings include aluminides and platinum aluminides. Pack cementation is a common method whereby metallic vapors of the desired coating are carried to the surface of a target and diffused thereon. The advanced diffusion coatings are therefore somewhat involved by the difficulty of codepositing other metals along with aluminum onto the substrate surface.

A common overlay coating used for HPT components is known as MCrAlY. In the conventional formulation of MCrAlY, M represents one of the metals nickel, cobalt, or iron, or combinations thereof. In the designation MCrAlY, Cr, Al, and Y are the chemical symbols for chromium, aluminum, and yttrium. Some conventional MCrAlY formulations are discussed in the following U.S. Pat. Nos. 4,532,191; 4,246,323; and 3,676,085. Families of MCrAlY compositions are built around the nickel, cobalt, or iron constituents. Thus the literature speaks of NiCrAlY, NiCoCrAlY, CoCrAlY, CoNiCrAlY, and so on.

The family of MCrAlY coatings offer an alternative to the diffusion-based coatings in that elements beyond aluminum and platinum are included in the coating, which brings an attendant improvement in corrosion and/or oxidation resistance. However, the MCrAlY coatings are not diffusion coatings and result in a distinct layer from the substrate as the coating; hence they are often referred to as overlay coatings. Since the coatings are deposited on the component surfaces as an alloy composition and in thicknesses often much greater than 0.002 inches, the MCrAlY coatings generally act independently of the substrate for providing the oxidation/corrosion protection. Many high temperature overlay coatings are produced by processes such as PVD, EBPVD, HVOF and LPPS.

The prior art methods of providing environmental and bond coatings have experienced limitations and drawbacks. For example in the case of overlay coatings, it is difficult with spray techniques to obtain a homogenous, high-quality, dense coating. The physical vapor deposition process faces difficulty in deposition rates and in efficiently applying cost effective coatings. Another limitation is the difficulty in matching the thermomechanical and physical properties of the overlay coatings to the substrate alloy and in commensurate with the corrosion/oxidation performance requirements. In particular, the coefficient of thermal expansion (alpha value) over the operating temperature regime should be comparable and matched with that exhibited by the superalloy substrate. Mismatched alpha value coatings exhibit cracking and spallation behavior. Additionally, thicker coatings are more prone to the spallation problem. Furthermore, the reaction zone interface that develops between an overlay coating and substrate material can accentuate coating incompatibility. Thus there is a need for alternative and improved methods of applying MCrAlY coatings.

One intent of the present invention is to provide methods involving diffusion processes to produce MCrAlY-type coatings. Such diffused coatings are however, produced by converting the substrate surfaces into MCrAlYX coating formulations where M is Fe, Ni, Co, or combinations thereof. X can be additive elements such as Hf, Si, Zr, Ta, Re, and others individually or in combination thereof.

One method used for providing diffusion coatings is the pack cementation process. In this method the target, the industrial item to be coated, is placed in a box or retort with a “pack” surrounding it. The pack typically includes a source of the metal (and other elements) to be diffused into the target, inert packing material, and an activator if any. Typically the target lies in a bed of mixed powdered materials. The box containing the target and its surrounding pack is then placed in an oven where the materials are heated for a desired time at a desired temperature. Diffusion of desired elements takes place during the thermal cycle. Pack cementation is a comparatively attractive method of coating in that it is a relatively simple method that is relatively inexpensive to apply to the target, as compared to other overlay methods of coating superalloys.

In the pack cementation process, elemental diffusion coatings on an article are produced through essentially a chemical vapor deposition procedure. The metallic elements in the pack react with the halide activator to form halide precursors which upon transport to the articles (substrates) react with the substrate surface to form the protective coatings. The material transfer reactions at the surface may involve adsorption and dissociation; and the various reactions involved in coating processes can become somewhat complex. Hence, several commercially practiced coatings involving more than one elemental diffusion reaction utilize multiple sequential steps to diffuse single elements such as Cr, Al, and Si in order to achieve duplex coatings. The situation becomes increasingly more intricate with the need to diffuse more than two elements and subsequently develop an integral coating formation to produce MCrAlYX coatings.

Hence there is a need for an improved method to apply an MCrAlY-type coating. There is a need for an improved coating method that can be easily and cost-effectively applied as an alternative to overlay coating. Further it would be desired that the composition of the MCrAlY coating incorporate more active elements, such as Hf, Zr, Si, etc. in order to provide effective oxidation, corrosion, and sulfidation resistance over a broad temperature range. The present invention addresses one or more of these needs.

### SUMMARY OF THE INVENTION

In one embodiment, and by way of example only, there is provided a method for providing a coating on a surface of a target such as a turbine blade or nozzle comprising the steps of: forming an active elements modified chromium diffusion coating on the target surface; depositing noble metals to a thickness in the range of 3 to 6 microns on the target surface; performing a diffusion cycle on the target in the temperature range of approximately 1800° F. to 2000° F.; and performing an aluminizing step on the target to generate coating microstructures. The method may further include the step of performing a post coat diffusion treatment in the 1900° F. to 2025° F. temperature range. The step of forming an active elements modified chromium diffusion coating may include at least one active element from the group consisting of yttrium, tungsten, platinum, hafnium, and zirconium. Alternatively the step of forming a diffusion coating is a chromium diffusion alone. The step of depositing noble metals may include depositing a layer of platinum. The depositing of noble metal may take place through the procedure of electroplating or physical vapor deposition (PVD). The step of performing an aluminizing step may comprise a low activity (1975° F. for approximately 4 hours), intermediate activity, or high activity aluminization. The final coating may be between 0.002 to 0.006 inches in thickness.

Other independent features and advantages of the low cost innovative diffused MCrAlY coatings will become apparent from the following detailed description, taken in conjunction with the accompanying drawings which illustrate, by way of example, the principles of the invention.

### BRIEF DESCRIPTION OF THE DRAWINGS

FIG. 1 is a schematic view of a turbine blade that may be used in an embodiment of the present invention.

FIG. 2 is a flow chart showing steps in the formation of a diffused MCrAlYX coating according to one embodiment of the present invention.

FIG. 3 is a flow chart showing steps in formation of a diffused MCrAlYX coating according to another embodiment of the present invention.

FIG. 4 is a flow chart showing steps in the formation of a diffused MCrAlYX coating containing noble metals according to a further embodiment of the present invention.

FIG. 5 is a flow chart showing processing steps in the formation of a diffused MCrAlYX coating containing noble metals according to a still further embodiment of the present invention.

FIG. 6 is a perspective view of an apparatus used in the pack cementation method according to an embodiment of the present invention.

FIG. 7 is a perspective view of an apparatus used in the out-of-pack diffusion method according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

It has now been discovered that an alternative means for an MCrAlY coating formation, to combat corrosion, oxidation, and sulfidation, can be achieved for high temperature applications in fields such as aerospace, power generation, chemical and petrochemical processing. In particular the method may be applied to gas turbine engine components by a deposition of materials onto the surface of the component. In this method a diffusion MCrAlYX-type coating is developed through single or multiple steps of pack diffusion and/or chemical vapor deposition. Metals that may be used in the deposition include chromium, aluminum, hafnium, silicon, yttrium and other desirable elements. The components of the alloy are selected to yield improved and enhanced environmental performance.

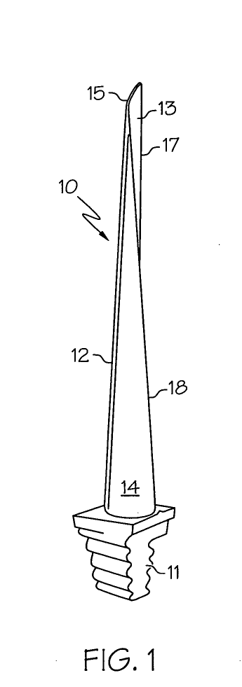

Referring now to FIG. 1 there is shown a gas engine turbine blade 10 which is a typical target for use with the coatings of the present invention. In general, turbine blade geometry and dimension are designed differently, depending on the turbine engine model and its application. For aero engines, such a blade is typically several inches in length. A turbine blade includes a serrated base assembly 11, also called a mounting dovetail, tang, or Christmas tree. Airfoil 12, a cuplike structure, includes a concave face 13 and a convex face 14. In the literature of turbine technology airfoil 12 may also be referred to as a bucket. Turbine blade 10 also includes leading edge 17 and trailing edge 18 which represent the edges of airfoil 12 that firstly and lastly encounter an air stream passing around airfoil 12. Turbine blade 10 also includes tip 15. Tip 15 may include raised features known as “squealers” (not shown) in the industry. Turbine blade 10 is often composed of a highly durable material such as a nickel-based superalloy. It is also desirable to cast turbine blades as directionally solidified or as a single crystal superalloy in order to maximize elevated-temperature mechanical properties and dimensional stability.

In one preferred embodiment, airfoil 12 is coated with a coating of the present invention on a surface. Airfoil surfaces and gas path surfaces are exemplary areas that may be coated. The Christmas tree structure 11 is not coated. Alternatively, all surfaces of blade 10 may be coated, and subsequently the dovetail may be machined. A gas turbine engine nozzle surface (and other HPT components) may also be coated, by the diffusion MCrAlY process.

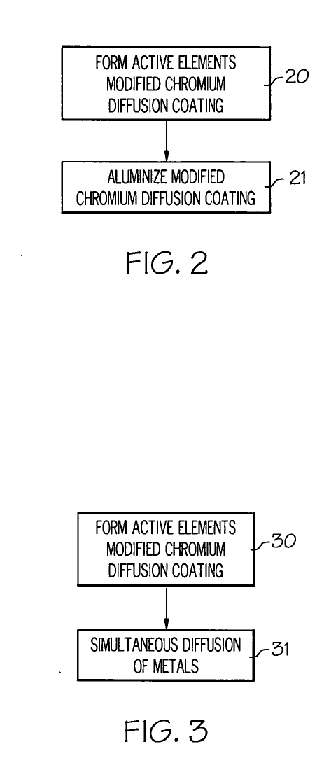

Referring now to FIG. 2 there is shown a set of steps for an MCrAlYX coating according to one embodiment of the present invention. In one form of coating, a first step 20 is the formation of an active elements modified chromium diffusion coating. This is accomplished in the chromium diffusion coating by including active elements such as hafnium, silicon, and yttrium. Also other elements such as Ta, Zr, Re, or combinations thereof, representing X can be included in this step. A second step 21 is the aluminization of the coating using low activity or high activity or a mixed intermediate activity aluminizing process. The aluminization step generates a diffused MCrAlYX type coating.

For the aluminization of step 21, a high activity process is preferred to retain the full benefit of the elemental chemistries of step 20 at the surface of the coating. Also, the high activity aluminization process will allow for the development of up to 0.006 inches in coating thickness. On the other hand, a low activity aluminization process will produce a graded coating structrure with the elemental chemistries of step 20 shifted down to the mid region of the formed coating. Also due to the diffusion characteristics, the low activity process is preferred to generate thinner, 0.002 inches to 0.004 inch, range coatings. Utilization of the mixed intermediate activity aluminizing process would in effect generate coating structures which are in between the high and low activity generated coatings.

The general composition range for the useful application of diffused MCrAlYX type coatings include (by weight) 10-35% Cr, 0-40% Co, 6-25% Al, 0-6% Hf, 0-5% Zr, 0-5% Ta, 0-5% Si, 0.01-0.9% Y, and the balance Ni.

Referring now to FIG. 3 there is shown a set of steps for forming an MCrAlYX coating according to another embodiment of the present invention. In another form of coating, a first step 30 is an in-pack or out-of-pack chromium diffusion coating. A subsequent step 31 is the simultaneous diffusion of metals such as hafnium, silicon, yttrium, and aluminum. Other desirable elements, as before, may also be included in the diffusion. The diffusion of the elements may be selected through the control of the thermodynamic activities of the precursors of the elements.

For example, chloride and/or fluoride activators can be selected so that the activities of precursor halides of desired elements such as hafnium, silicon, yttrium, and aluminum can be made comparable for codeposition. This can also be achieved by the use of specially formulated alloy powders. As is also known in the art, nuggets may be used in which the thermodynamic activities of desired elements are changed from the unit activity of pure individual metals. Some examples of the formulated special alloys in weight percent are: a) 25% Hf, 5% Ni, 0.5% Y, 10-20% Al, and the balance Si; b) 30% Hf, 10% Ni, 0.5% Y, 10-20% Al, and the balance Si; and c) 40% Hf, 15% Ni, 0.5% Y, 10-2-% Al, and the balance Si. The specially formulated alloy content in the pack can be varied from between approximately 2 to approximately 20% (by weight). This allows the transportation of precursors through varying concentrations of Hf, Si, Y, Al, etc., and subsequently the deposition and diffusion of elements to generate diffused MCrAlYX coatings.

The general composition range for the useful application of diffused MCrAlYX type coatings include (by weight): 10-35% Cr, 0-40% Co, 6-25% Al, 0-6% Hf, 0-5% Zr, 0-5% Ta, 0-5% Si, 0.01-0.9% Y, and the balance Ni.

In another preferred embodiment, the above methods may be modified with a combination of diffusion process steps and noble metal deposition steps. These process steps can generate additional coatings of the present invention. There are two preferred methods that may be used to produce the coatings of the current disclosure.

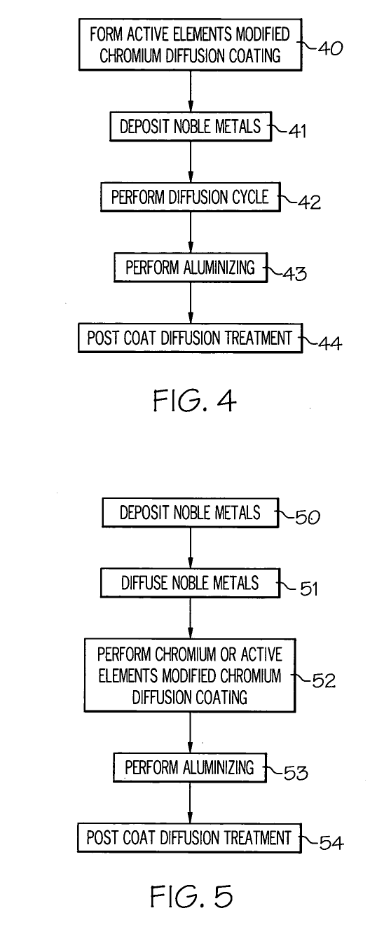

The first method, referred to as Method A, requires performing on superalloy parts, a set of sequential processing steps. These steps, shown in FIG. 4, include:

(1) (step 40) forming an active elements modified chromium diffusion coating on the surface of the article;

(2) (step 41) depositing noble metals such as platinum to a thickness in the range of 3 to 6 microns through known procedures such as electroplating or PVD techniques;

(3) (step 42) performing a diffusion cycle in the temperature range of approximately 1800° F. to 2000° F. to form a Ni/Cr/Pt layer with active elements on nickel-based superalloy materials;

(4) (step 43) performing an intermediate activity or high activity aluminizing, preferably to generate coating microstructures; and

(5) (step 44) optionally performing a post coat diffusion treatment in the 1900° F. to 2025° F. temperature range.

The second method, referred to as Method B, also requires a series of sequential processing steps on a superalloy part. These steps shown in FIG. 5 include:

(1) (step 50) depositing Noble metals such as platinum to a thickness in the range of about 3 to 6 microns as noted in step 41 of Method A;

(2) (step 51) diffusing Noble metal in the 1800° F. to 2000° F. temperature range;

(3) (step 52) performing an active elements modified chromium diffusion coating;

(4) performing an aluminizing step (step 53); and

(5) post diffusion treatment (step 54) as noted in method A.

The general composition range for the above Method A and Method B processes, which incorporate Noble metals such as Pt, Rh, Pd, etc., in the diffused MCrAlYX include (by weight) 10-35% Cr, 0-40% Co, 6-25% Al, 5-25% Pt, (or Rh or Pd or a combination thereof), 0-6% Hf, 0-5% Zr, 0-5% Ta, 0-5% Si, 0.01-0.9% Y, and the balance Ni.

In the methods above-described it is stated to perform an active elements modified chromium diffusion (or chromium diffusion). The following description is taken from copending patent application Ser. No. 10/836,791, for IMPROVED CHROMIUIM DIFFUSION COATINGS, filed Apr. 30, 2004, which is incorporated herein by reference. The description is an acceptable method of providing such a step.

In one preferred embodiment a diffusion packing is prepared using chromium or chromium alloy powder, master alloy powders of active elements and/or active metal elements in elemental or alloy form, a single or multiple activator, and an inert filler. Preferably the metallic powders that are used have a mesh size equal to or below 140 mesh. The metallic powders comprise the individual elemental metals or alloys thereof.

The metals in the pack include chromium and master alloy powders consisting of the desired active elements. The chromium source may be elemental chromium or chromium alloy. Preferably a high purity chromium powder is used. Active elements may include silicon, hafnium, zirconium, yttrium, tantalum, and rhenium. Again these active elements can be present in elemental form, or in alloy form, or a combination of both. Preferably all metal sources, whether elemental or alloy, are present in a flowable powder under 140 mesh size.

In one embodiment, master alloys of a desired metallic composition are first prepared. The alloy composition includes those metallic elements that it is desired to be co-deposited by the diffusion process. Once the alloy is formed, for example in ingot form, the solid alloy can be ground or pulverized in order to create the powder to be used in the packing. The solid alloy may thus be pulverized to a desired particle size suitable for the diffusion process. The master alloy powders can also be produced through the conventional atomization techniques used for powder production from molten alloys. In a further embodiment, it is preferred to combine an elemental chromium powder with a powder of a master alloy formulated to contain desired active elements.

Preferred activators include halide sources such as sources of fluorine, chlorine, iodine, and bromine. Acceptable activators include ammonium chloride, ammonium iodide, ammonium bromide, ammonium fluoride, ammonium bifluoride, elemental iodine, elemental bromine, hydrogen bromide, aluminum chloride, aluminum fluoride, aluminum bromide, and aluminum iodide. Preferred activators include ammonium chloride (NH₄Cl) and ammonium fluoride (NH₄Fl), and ammonium bifluoride.

In one embodiment it is preferred to use dual activators, that is, both a fluorine and a chlorine source within the same pack. Concentration of the halide source within the packing may be up to 20% by weight, and more preferably is up to 8% by weight. In one preferred embodiment, the halide concentration is between approximately 1% and approximately 5% by weight. Optionally, multiple activators may be various combinations of the identified halide compounds.

In one embodiment an activator is included in the packing that is in an encapsulated form. Such encapsulated activators are available from Chromalloy Israel, Ltd, Israel. An encapsulated activator is an activator, such as a halide compound, with a covering that surrounds the activator. The encapsulation thus acts to protect the halide from the surrounding environment and also minimizes any reactions the halide compounds might otherwise undergo. The encapsulating material, typically an organic polymer, evaporates during heating at which time the halide compound is released to participate in the diffusion process. A practical advantage of using the encapsulated form of activator is that it extends the useful shelf life of a packing. Thus a packing can be mixed, prepared, or manufactured at one location and then distributed to repair facilities. The packing can then be stored at the repair facilities until needed without losing its effectiveness.

Inert materials include metal oxides such as alumina Al₂O₃. Other preferred inert materials include kaolin, MgO, SiO₂, Y₂O₃ or Cr₂O₃. The inert fillers may be used singly or in combination. Preferably the inert materials have a non-sintered, flowable grain structure so as not to interfere with the gas transport diffusion of the desired metals.

The packing of the present invention can have varying concentrations of the metallic components within them. In one embodiment, the chromium concentration is between about 5 to about 20%; and the master alloy powder consisting of active elements (Hf, Si, Y, and others) is between about 1% to about 20% by weight. In another embodiment the chromium concentration is between about 5% to about 20%, silicon is between about 0.5% to about 10%; hafnium is between about 0.5 to about 8%; yttrium is between about 0.05 to about 5.0%; and other elements are between about 0 to about 5%, where the other elements include refractory elements such as tantalum, rhenium, zirconium etc. Also to be included are alloys of these metals. The metallic materials may also be used in nugget shape instead of powders.

It is also included within the scope of the invention to use mixtures of about 5% to about 20% chromium, about 1.0% to about 20% master alloy powder 0 to about 5.0% of active elements (Hf, Si, and Y), and 0 to about 5% refractory elements Ta, Re, and Zr.

These percentages are measured on a weight percentage basis comparing the metal to metal concentrations. As a whole, the metal component in the packing for coating (which includes activator and inert materials) can be between about 10% to about 90% with a range of about 15% to about 25% being preferred.

Other preferred embodiments of the active element composition include alloys of chromium, hafnium, nickel, yttrium, and silicon. Alternatively, a desired formulation can be created by combining chromium powder with a powdered master alloy of hafnium, nickel, yttrium, and silicon. Preferred formulations of these embodiments are based on a pack composition comprising approximately 15 to 40% by total weight metal or metal alloy powder, approximately 1 to 5% by weight activator, and the rest inert material such as alumina. A preferred formulation comprises approximately 20% by weight metal powder, approximately 2% activator, and the rest inert material. Some preferred compositions of the active elements component master alloy are as follows, with weight percentages being approximate:

| | Nominal Composition of Master Alloy | | | | |
|---|---|---|---|---|---|
| | A | B | C | D | E |
| Hf | 25% | 30% | 40% | 30% | 40% |
| Ni | 5% | 10% | 15% | 15% | 20% |
| Y | 0.5% | 0.5% | 0.5% | 5.0% | 10% |
| Si | bal. | bal. | bal. | bal. | bal. |

Chromium is then added to these compositions to reach a desired level of total metal in the alloy or in the pack, such as between 15% and 40%. In a preferred embodiment, master alloys of hafnium, nickel, yttrium, and silicon are prepared. Powders of this alloy are then combined with chromium powder as the metal additive in the pack.

A further embodiment adds additional materials such as zirconium, rhenium, and tantalum. These metals can be added up to 5% by weight in formulations A, B, C, D and E. Preferably these materials are included in the same alloy as that including hafnium, nickel, yttrium, and silicon.

It is within the scope of the invention to provide metal powder that is either elemental of each metal or is an alloy of metals. Further the combination of metals in elemental form with metals in alloy form can be adjusted to affect the thermodynamic activity with respect to a given halide activator or activators. Metals in their elemental form tend to have a higher activity for the formation of halide precursors. Elements in the master alloy powders tend to provide a lower activity. Thus, for example if it is desired to increase the diffusion of a given metal, it can be added to the pack in elemental form.

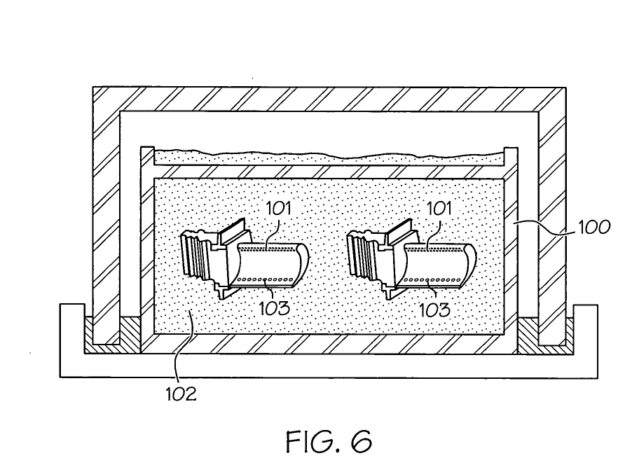

The packings of the present invention are intended for use with known pack cementation methods. Referring now to FIG. 6 there is shown an illustration of pack cementation equipment for use with the present invention. A retort or box 100 provides a closed container in which the target item rests. Box 100 may include a lid or other opening. If desired the lid may be affixed to the box structure as by welding so as to preclude the entrance of oxygen. Target 101 is placed within box 100. Box 100 and lid are composed of materials such as wrought nickel based superalloys or stainless steel metal capable of withstanding heating to elevated temperatures.

The target item that is to be coated may receive a surface preparation in order to facilitate the diffusion process. The preparation may include an inspection, degreasing, and blast cleaning. Further the part may be rinsed with an evaporative solvent to remove any remaining particulate residues and contaminants.

The target 101, such as a turbine blade, is placed in the box 100. A pack 102 is also placed within box 100 such that pack 102 surrounds target 101. Pack 102 includes metal powder, activators, and inert materials of the kinds and quantities as above-described. Pack 102 further acts to support target 101 so that the target is surrounded by metals in the pack.

In an alternative embodiment, dual activators are used in which a first activator and a second activator are included in the pack. In a preferred embodiment, the first activator comprises a first halide compound, such as a chlorine-containing compound, and the second activator comprises a second halide, such as a fluorine-containing compound. Use of the dual halides can advantageously benefit the thermodynamics and reaction kinetics of the different metals also present in the pack. Thus chlorine will serve to assist the activation of one species and fluorine can assist the activation of another species.

Once the materials for the pack 102 have been selected and assembled, and the target item has been prepared for diffusion, the materials may be placed in box 100 and sealed. A coating thermal cycle then takes place. The coating heat treatment includes heating the box and contents to the coating temperature at a controlled heat up rate and holding at a constant temperature, up to 2100° F. for up to twelve hours. A preferred heat treatment is heating to a constant coating temperature between about 1800° F. to about 2050°0 F. for approximately 10 hours.

During the heat treatment a mass transport and diffusion process takes place. Metal ions such as chromium react with halide ions. These molecules migrate to the surface of the target through gas transport process. At the surface of the metallic target various metal transfer mechanisms occur, for example, a metal ion such as chromium diffuses with the materials in the target substrate. Temperature and time affect the kinetics of this process. It is also preferred to carry out the heat treatment under an inert atmosphere, hydrogen, or vacuum. In some embodiments argon or hydrogen can be flowed through the box in order to maintain an acceptable atmosphere and to assist with mass transport mechanisms.

In a further embodiment, the improved chromium diffusion coating can be obtained using an “out-of-pack” coating process. This embodiment is particularly suited for providing coatings on surfaces of the internal regions of turbine blades. Often turbine blades include openings or passages that provide fluid communication between the exterior of the turbine blade and its hollow interior regions. During engine operation air passes through the interior for cooling purposes. However, this passage of air can also lead to corrosion, oxidation, and sulfidation of the metal of the turbine blade. Thus it is desired to coat these internal passage areas. Given the small passages between the exterior and interior of a turbine blade, a traditional in-pack cementation apparatus may not be able to provide adequate vapor phase materials that efficiently reach the interior of the turbine blade. Thus the diffusion coating on a turbine blade interior that results from a traditional pack cementation is often less than desired. An alternative arrangement, an out-of-pack diffusion is thus preferred to diffusion coat the interior of a turbine blade.

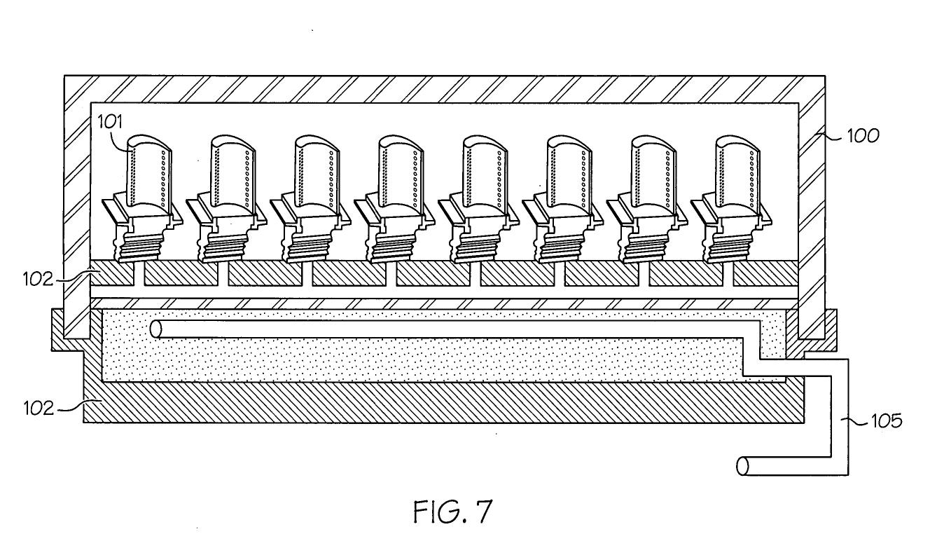

Referring now to FIG. 7 in an out-of-pack process, diffusion gases are flowed through a space to receive a coating. A typical arrangement includes a box 100, target 101, and packing 102. Target 101 is typically positioned so that it is within box 100 but above, or “out of” the packing 102. Additionally an out-of-pack arrangement includes tubing 105. Tubing 105 is a ductwork or series of passageways that provides fluid communication between packing 102 and target 101. Tubing 105 includes openings (not shown) through which gases generated from packing 102 may pass into tubing 105. Tubing 105 further includes leads that direct gases into the interior of a target 101. An inert gas and/or flows through tubing 105 thereby carrying the gases from the packing to target 101. Thus, in the example of a turbine blade, gases are passed into turbine blade passageways and through the hollow interior of the turbine blade. Gases may exit through apertures 103 (shown in FIG. 6) of the object.

In an out-of-pack process, packing 102 still includes the desired metals, activator, and inert material. When the box 100 is heated, the activator and metals react to form gases such as metal halides. These gases are drawn into tubing 105 and passed into the interior of target 101. When gases enter target 101 surface diffusion takes place such that the desired metals are diffused into the internal surfaces of target 101.

The heating step in an out-of-pack diffusion process is similar to that of a traditional pack cementation apparatus. The pack and target are heated to a desired temperature, between 180° F. and 2050° F. and the temperature is held constant for a desired period of time. Preferably this is between 8 to 10 hours.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for providing a diffused MCrAlYX coating on a surface of a target comprising the steps of:
forming an active elements modified chromium diffusion coating on the target surface;
depositing noble metals to a thickness in the range of 3 to 6 microns on the target surface;
performing a diffusion cycle on the target in the temperature range of approximately 1800° F. to 2000° F. to diffuse the noble metals; and
performing an aluminizing step on the target to generate coating microstructures.

2. The method according to claim 1 wherein the active-elements modified chromium diffusion coating comprises (by weight) 10-35% Cr, 0-40% Co, 6-25% Al, 0-6% Hf, 0-5% Zr, 0-5% Ta, 0-5% Si, 0.01-0.9% Y, and the balance Ni.

3. The method according to claim 1 further comprising the step of performing a post coat diffusion treatment in the 1900° F. to 2025° F. temperature range.

4. The method according to claim 1 wherein the step of forming an active elements modified chromium diffusion coating includes at least one active element from the group consisting of yttrium, platinum, hafnium, zirconium, and silicon.

5. The method according to claim 1 wherein the step of performing a diffusion cycle is performed with active elements.

6. The method according to claim 1 wherein the step of forming a diffusion coating further comprises diffusion with yttrium.

7. The method according to claim 1 wherein the step of depositing noble metals comprises depositing a layer of platinum.

8. The method according to claim 1 wherein the step of depositing noble metals further comprises depositing through the procedure of electroplating.

9. The method according to claim 1 wherein the step of depositing noble metals further comprises depositing through the procedure of PVD.

10. The method according to claim 1 wherein the step of performing an aluminizing step comprises a low activity aluminization.

11. The method according to claim 10 wherein the aluminizing step comprises heating at approximately 1975° F. for approximately 4 hours using an out of pack procedure.

12. The method according to claim 1 wherein the step of performing an aluminizing step comprises an intermediate activity aluminization.

13. The method according to claim 1 wherein the step of performing an aluminizing step comprises a high activity aluminization.

14. The method according to claim 1 wherein the coating is approximately 0.002 inches to approximately 0.006 inches in thickness.

15. A method for providing a coating on a surface or a target comprising the steps of:
depositing noble metals on the target surface to a thickness in the range of 3 to 6 microns;
diffusing the noble metals in the 1800 to 2000° F. temperature range;
performing an active elements modified chromium diffusion coating on the target surface;
performing a diffusion cycle on the target in the temperature range of approximately 1800° F. to 2000° F.; and performing an aluminizing step to generate coating microstructures on the target.

16. The method according to claim 15 wherein the step of performing a diffusion cycle is performed with active elements.

17. The method according to claim 15 further comprising the step of performing a post coat diffusion treatment in the 1900° F. to 2025° F. temperature range.

18. The method according to claim 15 wherein the step of forming an active elements modified chromium diffusion coating includes at least one active element from the group consisting of yttrium, platinum, hafnium, zirconium, and silicon.

19. The method according to claim 15 wherein the step of depositing noble metals comprises depositing a layer of platinum.

20. The method according to claim 15 wherein the step of depositing noble metals further comprises depositing through the procedures of electroplating.

21. The method according to claim 15 wherein the step of depositing noble metals further comprises depositing through the procedures of physical vapor deposition.

22. The method according to claim 15 wherein the step of performing an aluminizing step comprises a low activity aluminization.

23. The method according to claim 22 wherein the aluminizing step comprises heating at approximately 1975° F. for approximately 4 hours using an out of pack procedure.

24. The method according to claim 15 wherein the step of performing an aluminizing step comprises an intermediate activity aluminization.

25. The method according to claim 15 wherein the step of performing an aluminizing step comprises a high activity aluminization.

26. The method according to claim 15 wherein the coating is approximately 0.002 inches to approximately 0.006 inches in thickness.

27. A component having a surface with a coating wherein the coating comprises by weight percent:
approximately 10 to approximately 35% Cr;
approximately 0 to approximately 40% Co;
approximately 6 to approximately 25% Al;
approximately 0 to approximately 6% Hf;
approximately 0 to approximately 5% Zr;
approximately 0 to approximately 5% Ta;
approximately 0 to approximately 5% Si;
approximately 0.01 to approximately 0.9% Y; and
the balance nickel.

28. The component according to claim 27 wherein the coating further comprises by weight percent approximately 5 to approximately 25% platinum.

29. The component according to claim 27 wherein coating is disposed on the surface of a turbine blade.

30. The component according to claim 27 wherein the coating is disposed on the surface of a nozzle.

31. The component according to claim 27 wherein the coating is provided through a process including diffusion.
